(19) United States
(12) Patent Application Publication
(10) Pub. No.: US 2009/0262520 A1
(43) Pub. Date: Oct. 22, 2009

(54) Backlight unit using a thermoplastic resin board

(75) Inventors: Ho-Joon Park, Seoul (KR); Jin-Cheol Kim, Hwaseong-si (KR); Sang-Jun Yoon, Seoul (KR); Geum-Hee Yun, Yongin-si (KR); Jun-Rok Oh, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/230,104

(22) Filed: Aug. 22, 2008

(30) Foreign Application Priority Data
Apr. 17, 2008 (KR) 10-2008-0035644

(51) Int. Cl. G09F 13/04; F21V 21/00

(52) U.S. Cl. 362/97.1

(57) ABSTRACT

A backlight unit is disclosed. The backlight unit may include a thermoplastic resin board in which cavities may be formed, a light emitting diode (LED) component which may be mounted on a bottom surface of the cavity, and a molding resin which may be filled in the cavity and which may secure the light emitting diode component. The thermoplastic resin board may include a light-reflective filler, to improve reflection efficiency, dispersed within the thermoplastic resin board. According to certain embodiments of the invention, a simple process can be utilized to reduce the thickness of the backlight unit, making it applicable to compact devices.

### CROSS-REFERENCE TO RELATED APPLICATIONS

This application claims the benefit of Korean Patent Application No. 10-2008-0035644 filed with the Korean Intellectual Property Office on Apr. 17, 2008, the disclosure of which is incorporated herein by reference in its entirety.

### BACKGROUND

1. Technical Field

The present invention relates to a backlight unit, more particularly to a backlight unit that includes light emitting diodes and a thermoplastic resin board.

2. Description of the Related Art

The light emitting diode (LED) is widely being used in signboards, display devices, automobiles, traffic lights, backlights, and regular lighting devices, and its use is expected to continue into the future. While liquid crystal display (LCD) devices, as used in monitors, laptops, and mobile communication terminals, etc., are currently receiving much attention, due to the low energy consumption and compact sizes provided by such devices, an LCD device may be unable to generate light itself. Thus, an LCD device may generally be equipped with a backlight, which serves as a light source, generating light from the back or the sides the LCD panel. As light emitting diodes may typically be used in the backlight, developments in LCD devices are prompting developments also in the field of light emitting diodes.

An LED light source used in a backlight unit may take the form of a light emitting diode module, which may include numerous light emitting diodes mounted on a board. The light emitting diodes may each be sealed with a fluorescent substance and a silicone resin inside a frame, and may be attached onto a printed circuit board made from an epoxy material, to form a backlight unit.

A description will be provided as follows, with reference to FIG. 1, on the composition of a backlight unit according to the related art. FIG. 1 is a side elevational view illustrating the structure of a backlight unit according to the related art.

As illustrated in FIG. 1, a backlight unit based on the related art may include a PCB 110, a reflective film 120, frames 130, light emitting diode components 140, and a molding resin 150 that includes a fluorescent substance.

The PCB 110 may be formed from an epoxy material, and a reflective film 120 may be attached to one side of the PCB 110. The reflective film 120 may be formed in order to prevent the PCB 110 from reducing the optical efficiency and causing thermal deterioration in the light emitting diode components 140. The light emitting diode components 140 may be mounted inside the number of frames 130 formed over the reflective film 120, after which the insides of the frames 130 may be sealed with a molding resin 150 containing a fluorescent substance, to package the backlight unit. A backlight unit thus composed may require an expensive reflective film 120, and the use of the reflective film may entail several processes while increasing the thickness of the backlight unit.

### SUMMARY

An aspect of the invention provides a backlight unit in which the reflective film is removed to provide a smaller thickness.

Another aspect of the invention provides a backlight unit that can be manufactured using a simple process and with a low cost.

Yet another aspect of the invention provides a backlight unit that includes: a thermoplastic resin board in which cavities may be formed, a light emitting diode (LED) component which may be mounted on a bottom surface of the cavity, and a molding resin which may be filled in the cavity and which may secure the light emitting diode component. The thermoplastic resin board may include a light-reflective filler, to improve reflection efficiency, dispersed within the thermoplastic resin board.

Here, the thermoplastic resin board can be formed from any one of polyetherimide (PEI), polyethersulfone (PES), polyetheretherketone (PEEK), polytetrafluoroethylene (PTFE), and a liquid crystal polymer, or a combination of the above. The thermoplastic resin board may further include a thermally conductive filler in a dispersed form and/or may further include a glass cloth dispersed in a dispersed form.

Also, the light-reflective filler can include any one of titanium dioxide (TiO₂), lead carbonate (PbCO₃), silica (SiO₂), zirconia (ZrO₂), lead oxide (PbO), alumina (Al₂O₃), zinc oxide (ZnO), and antimony trioxide (Sb₂O₃), or a combination of these compounds. The molding resin can contain a fluorescent material.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a side elevational view illustrating the structure of a backlight unit according to the related art.

FIG. 2 is a side elevational view of a backlight unit according to an embodiment of the present invention.

FIG. 3 is a graph illustrating changes in reflectivity with respect to wavelength, for various light reflective fillers used in a backlight unit according to an embodiment of the present invention.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various elements, such elements must not be limited to the above terms. The above terms are used only to distinguish one element from another. For example, a first element may be referred to as a second element without departing from the scope of rights of the present invention, and likewise a second element may be referred to as a first element. The term “and/or” encompasses both combinations of the plurality of related items disclosed and any item from among the plurality of related items disclosed.

When an element is mentioned to be “connected to” or “accessing” another element, this may mean that it is directly formed on or stacked on the other element, but it is to be understood that another element may exist in-between. On the other hand, when an element is mentioned to be “directly connected to” or “directly accessing” another element, it is to be understood that there are no other elements in-between.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Embodiments of the present invention will be described below in detail with reference to the accompanying drawings.

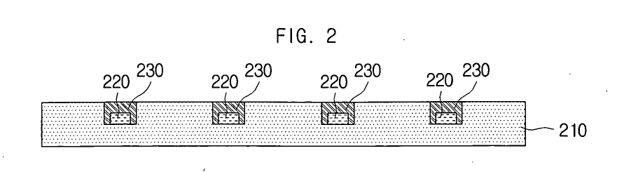

FIG. 2 is a side elevational view of a backlight unit according to an embodiment of the present invention. A backlight unit according to an embodiment of the invention may include a thermoplastic resin board 210, light emitting diode components 220, and a molding resin 230.

A backlight unit according to an embodiment of the invention can be formed with light emitting diode components 220 mounted on a thermoplastic resin board 210 in which multiple cavities are formed.

As illustrated in FIG. 2, the multiple number of cavities formed in the thermoplastic resin board 210 can be formed in constant intervals. However, the cavities in the thermoplastic resin board 210 need not always be formed in constant intervals. Also, although there are four cavities formed in the thermoplastic resin board 210 shown in FIG. 2, it is apparent to those skilled in the art that the number of cavities may vary without departing from the spirit of the invention. Furthermore, in addition to the form of a bar, as illustrated in FIG. 2, in which the multiple cavities are formed in a row in one side, a backlight unit according to this embodiment can be manufactured in a variety of forms without departing from the spirit of the invention.

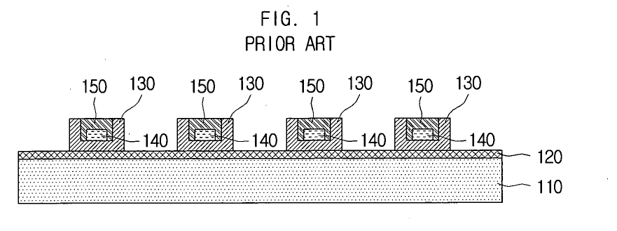

As the light emitting diode components 220 may be mounted inside these cavities, the frames used in a conventional backlight unit, described above with reference to FIG. 1, may no longer be needed. In cases where frames are positioned over an upper portion of the board, such as in the conventional backlight unit, the thickness of the backlight unit cannot be lowered below a certain point, due to the height of the frames. However, in the case of a backlight unit according to the present embodiment, the light emitting diode components 220 may be mounted inside the cavities formed in the thermoplastic resin board 210. Thus, the frames are no longer necessary, and the frames can be removed, making it possible to lower the thickness of the backlight unit.

Also, a backlight unit according to this embodiment may include a thermoplastic resin board 210. In the case of a conventional backlight unit, the board may generally be formed from an epoxy material. The thermoplastic resin board 210 according to this embodiment, however, may be capable of implementing white light, and therefore the problem of degraded optical luminance in conventional backlight units can be resolved by utilizing the thermoplastic resin board 210.

When a thermoplastic resin is used to form the thermoplastic resin board 210 in the backlight unit, it is possible to manufacture the backlight unit to have a thin and long shape. The thermoplastic resin board 210 may form the base surface of the backlight unit and may serve to support the mounted light emitting diode components 220 in a stable manner. The thermoplastic resin board 210 may also be formed to resist the heat generated when the light emitting diode components 220 are operated. Therefore, the thermoplastic resin used for manufacturing the backlight unit may be such that exhibits high mechanical strength and thermal resistance at high temperatures.

Examples of thermoplastic resins that provide such thermal resistance and mechanical strength include polyetherimide (PEI), polyethersulfone (PES), polyetheretherketone (PEEK), polytetrafluoroethylene (PTFE), and liquid crystal polymers (LCP's), etc., which are known as high-performance engineering plastics. Liquid crystal polymers (LCP's) are especially favored from among these high-performance engineering plastics, due to superior characteristics in terms of thermal resistance and strength, dimensional stability, and molding workability, etc., as well as relatively inexpensive costs.

The thermoplastic resin board 210 of the backlight unit according to this embodiment may include a light-reflective filler dispersed in the thermoplastic resin board 210 to improve reflection efficiency. The light-reflective filler can be a ceramic filler, for example, that improves the optical efficiency, especially the reflection efficiency, of the thermoplastic resin board 210. However, any of various other substances capable of improving the reflection efficiency of the thermoplastic resin board 210 can be dispersed in the thermoplastic resin board 210.

The role of the reflective film, utilized in the conventional backlight unit for reflecting the light emanating from the light emitting diode components so that the light may be emitted in one direction, can be fulfilled instead by the light-reflective filler dispersed in the thermoplastic resin board 210 according to the present embodiment. In other words, as the light-reflective filler dispersed in the thermoplastic resin board 210 may increase the reflection efficiency of the thermoplastic resin board 210, the light emitted from the light emitting diode components can be reflected and outputted in one direction. Thus, the reflective film included in the conventional backlight unit may be omitted, so that the thickness of the backlight unit may be decreased.

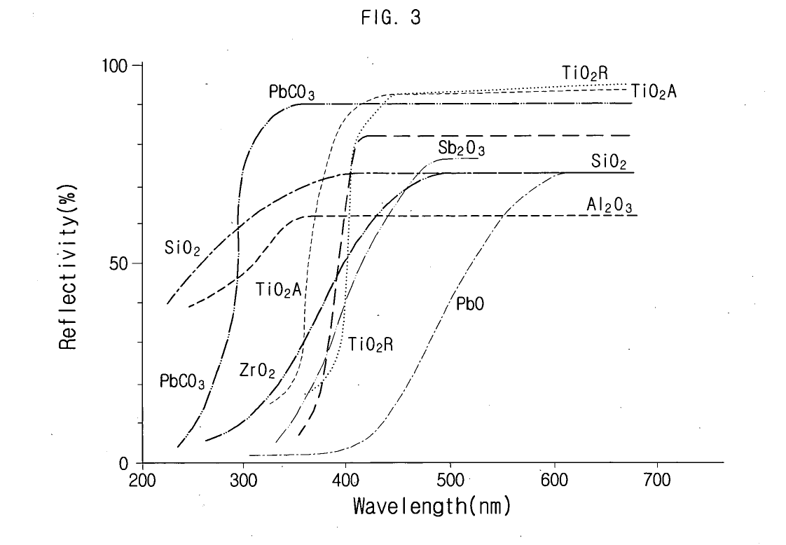

The light-reflective filler as described above can be a ceramic filler, such as titanium dioxide (TiO₂), etc., capable of increasing reflection efficiency. This will be described later in further detail with reference to FIG. 3.

The light emitting diode components 220 can be mounted on the bottom surfaces of the cavities formed in the thermoplastic resin board 210 and can be electrically connected with electrodes (not shown) by way of bonding material. That is, as illustrated in FIG. 2, a light emitting diode component 220 may be mounted in each of the multiple number of cavities. Thus, the light emitting diode components 220 may perform a light emitting operation in correspondence to electrical signals transferred through the bonding material and electrodes (not shown) from an external power supply. It is apparent to those skilled in the art that various methods can be used for the bonding, such as wire bonding and flip chip bonding, etc.

The molding resin 230 can secure and seal the light emitting diode components 220 and the bonding material. That is, the molding resin 230 may serve to protect the light emitting diode components 220 and preserve the form of the bonding material, as well as to prevent detaching and separation. A transparent silicone resin, epoxy molding compound (EMC), etc., may generally be used for the molding resin 230. Here, the molding resin 230 can include a fluorescent material, which may serve to enhance the light emitting properties or increase the light emitting efficiency when the light generated at the light emitting diode components 220 is outputted to the exterior of the backlight unit.

The backlight unit may be required to readily release the heat generated by the operation of the light emitting diode components 220. This is because if there is not sufficient heat release, the backlight unit may reach excessively high temperatures, which can cause malfunctioning in the light emitting diode components, such as changes in the wavelengths of the outputted light and shaky output, etc. Thus, a thermoplastic resin board 210 according to an embodiment of the invention may be manufactured to include a thermally conductive filler, in addition to the light-reflective filler. The thermally conductive filler may be a filler that provides superb thermal conductivity, for example a ceramic filler. However, it is apparent to those skilled in the art that the invention is not thus limited and that various fillers other than ceramic fillers may be used without departing from the spirit of the invention. Manufacturing the thermoplastic resin board 210 with a ceramic filler having superior thermal conductivity and a low rate of thermal expansion, such as fused silica (SiO₂), alumina (Al₂O₃), boron nitride (BN), etc., dispersed within the thermoplastic resin board 210 can greatly contribute to enhancing heat release in the manufactured backlight unit. The thermally conductive filler can be any of a spherical type, flake type, and whisker type, or a combination of the above. When various types of thermally conductive fillers are used in the manufacture of the thermoplastic resin board 210, the combination of the several filler structures may provide different aspect ratios, which can lead to an increase in the mean free path of electrons and therefore result in improved thermal conductivity.

In this embodiment, the content of the thermally conductive filler in the thermoplastic resin board 210 of the backlight unit may vary within a range of 40 to 95wt %. However, if the content of the thermally conductive filler exceeds 70 wt %, the addition of the relatively high-priced thermally conductive filler can lead to increases in cost, while the high content may cause difficulties in the dispersing process, making it difficult to manufacture a uniform mold.

A thermoplastic resin board 210 according to another embodiment of the invention can further include glass clothes, in addition to the light-reflective filler, dispersed in the thermoplastic resin board 210. By including glass clothes in the thermoplastic resin board 210 in a dispersed form, the mechanical strength of the thermoplastic resin board 210 may be improved, including rigidity and flexibility.

A description will be provided as follows, with reference to FIG. 3, on the changes in reflectivity with respect to wavelength for light-reflective fillers according to an embodiment of the invention. FIG. 3 is a graph illustrating changes in reflectivity with respect to wavelength, for various light reflective fillers used in a backlight unit according to an embodiment of the present invention.

Inside the thermoplastic resin board in a backlight unit according to an embodiment of the invention, a light-reflective filler is dispersed, to improve reflection efficiency. Here, the light-reflective filler can be a type of a ceramic filler, and as described above, any material capable of improving reflection efficiency can be used, regardless of its type, in a backlight unit according to an embodiment of the invention.

The light-reflective filler can be any one of titanium dioxide (TiO₂), lead carbonate (PbCO₃), silica (SiO₂), zirconia (ZrO₂), lead oxide (PbO), alumina (Al₂O₃), zinc oxide (ZnO), and antimony trioxide (Sb₂O₃), or a combination of the above.

As illustrated in the graph of FIG. 3, the reflectivity of a light-reflective filler generally tends to increase with wavelength. In particular, at wavelengths of about 500 nm and higher, titanium dioxide (TiO₂) and lead carbonate (PbCO₃) show much higher reflectivity values compared to the other light-reflective fillers. Two types of titanium dioxide (TiO₂) are illustrated, namely, anatase (TiO₂A) and rutile (TiO₂R). Anatase and rutile are polymorphs, and the relationship between the two is well known to those skilled in the art.

In the case of anatase (TiO₂A) and rutile (TiO₂R), the reflectivity values are over 90% at wavelengths of 400 nm and higher, and although lead carbonate (PbCO₃) exhibits a reflectivity value lower than those of the titanium dioxide compounds (i.e. anatase and rutile), the reflectivity value is about 90% at a wavelength band of 350 nm and higher. Furthermore, most of the light-reflective fillers represented in the graph exhibit reflectivity values of over 50% at a wavelength band of 400 nm and higher.

As described above, a backlight unit according to an embodiment of the invention can include such light-reflective fillers having high reflectivity values in the thermoplastic resin board, so that the reflective film may be omitted, and a smaller thickness may be obtained compared to the conventional backlight unit. Moreover, a thermally conductive filler and/or a glass cloth, etc., can be dispersed within the thermoplastic resin board to improve heat release properties and mechanical strength.

According to certain embodiments of the invention as set forth above, a simple process can be utilized to reduce the thickness of the backlight unit, making it applicable to compact devices.

Also, according to certain embodiments of the invention, the heat from the light emitting diode components can be released in an efficient manner.

Furthermore, the reduction in optical efficiency due to thermal deterioration in the backlight unit can be prevented.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A backlight unit comprising:
a thermoplastic resin board having a plurality of cavities formed therein;
a light emitting diode (LED) component mounted on a bottom surface of the cavity; and
a molding resin filled in the cavity and securing the light emitting diode component,
wherein the thermoplastic resin board includes a light-reflective filler dispersed therein, the light-reflective filler configured to improve reflection efficiency.

2. The backlight unit of claim 1, wherein the thermoplastic resin board is formed from any one of polyetherimide (PEI), polyethersulfone (PES), polyetheretherketone (PEEK), polytetrafluoroethylene (PTFE), and a liquid crystal polymer, or a combination thereof.

3. The backlight unit of claim 1, wherein the thermoplastic resin board further comprises a thermally conductive filler dispersed therein.

4. The backlight unit of claim 1, wherein the thermoplastic resin board further comprises a glass cloth dispersed therein.

5. The backlight unit of claim 1, wherein the light-reflective filler comprises any one of titanium dioxide (TiO₂), lead carbonate (PbCO₃), silica (SiO₂), zirconia (ZrO₂), lead oxide (PbO), alumina (Al₂O₃), zinc oxide (ZnO), and antimony trioxide (Sb₂O₃), or a combination thereof.

6. The backlight unit of claim 1, wherein the molding resin contains a fluorescent material.
